(19) United States
(12) Patent Application Publication
(10) Pub. No.: US 2002/0049547 A1
(43) Pub. Date: Apr. 25, 2002

(54) Methods for assembly of genetic information

(76) Inventors: Serafim Batzoglou, Palo Alto, CA (US); Bonnie Berger, Newton, MA (US); Jill P. Mesirov, Belmont, MA (US); Eric Lander, Cambridge, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/880,467

(22) Filed: Jun. 13, 2001

Related U.S. Application Data
(60) Provisional application No. 60/211,461, filed on Jun. 13, 2000.

(51) Int. Cl. G06F 19/00

(52) U.S. Cl. 702/20

(57) ABSTRACT

Disclosed herein are methods and articles of manufacture for assembly of a plurality of reads from a genomic region that include the steps of indexing a plurality of read subsequences for each of a plurality of reads, extracting from the indexed subsequences a plurality of read pairs that have a predetermined number of subsequences in common, and merging the read pairs along a continuum. Also disclosed are methods and articles of manufacture for assembly of merged reads from a genomic region that include the steps of using linking information to identify one or more ambiguities in the merged reads, identifying a repeat region and a set of unique regions, and linking pairs of unique regions using the linking information associated with the reads in the unique regions.

### RELATED APPLICATION

This application claims priority to and the benefit of copending U.S. Provisional Patent Application Ser. No. 60/211,461, filed on Jun. 13, 2000, and entitled “A System and Method for Whole Genome Shotgun Assembly,” the entire disclosure of which is hereby incorporated by reference herein.

### GOVERNMENT SUPPORT

Work described herein was supported by Federal Grant Nos. 5 U54 HG02152 and 5 U54 HG02045, awarded by the National Institute for Health. The Government has certain rights in the invention.

### TECHNICAL FIELD

The present invention relates generally to genetic information, and more specifically, to methods for the assembly of genomic sequences.

### BACKGROUND OF THE INVENTION

A problem encountered with assembly of genetic information from DNA sequences is that errors, e.g., base substitutions and indels, are introduced in the sequences during sequencing so that overlap between sequences can be difficult to detect. Another problem is that current sequencing programs can only resolve relatively short genome segments, i.e., the BAC clone that is roughly 200,000 nucleotides long. Another problem is the difficulty in assembling repeat-rich genomes from sequences, e.g., 25% of the human genome are repeated about 2 or 3 times within the genome, because the ambiguities are difficult to resolve. Because of the repeat problem, it is thought that sequencing repeat-rich genomes is not feasible.

### SUMMARY OF THE INVENTION

A novel approach to the assembly of genetic information has now been discovered, thus providing a method of assembly of genomic sequences. By practicing the disclosed invention, the skilled practitioner can now, e.g., compare subsequences of the reads so that overlap can be detected despite sequence errors, significantly reduce the number of sequence comparisons necessary to detect overlaps, and resolve ambiguities due to the presence of repetitive regions in the genome by use of linking information. The advantages of the present invention include a feasible method of assembly of sequences that is efficient and trustworthy.

In one aspect, the invention features a method for assembly of a plurality of reads from a genomic region. The method includes the steps of providing a plurality of reads from a genomic region, indexing a plurality of read subsequences for each of the plurality of reads, each subsequence having an associated read with which it corresponds, extracting from the indexed subsequences a plurality of read pairs that have a predetermined number of subsequences in common, and merging the read pairs along a continuum.

The method can include the step of providing a plurality of reads generated from sequencing both ends of a plurality of DNA segments, each read having associated linking information including an associated orientation relative to a read from an opposite end of the DNA segment, and an associated distance from the read on the opposite end of the DNA segment. The method can include the step of providing a plurality reads that are reverse complements of a plurality of reads provided by sequencing both ends of a plurality of DNA segments. The method can include the step of sorting the indexed read subsequences. The method can include the step of discarding read subsequences having more than a cutoff number of occurrences from the plurality of indexed subsequences.

The method can include the step of indexing a plurality of read subsequences of a predetermined length for each of the plurality of reads. The predetermined length for each of the plurality of reads can be between about 12 and about 32 bases long.

The method can include the step of indexing a plurality of subsequences for each read, the index including for each subsequence an associated read and an associated position on the read with which it corresponds. The method can include the step of performing alignments on the plurality of read pairs having a predetermined number of subsequences in common. The alignments can be performed on the plurality of read pairs having a predetermined number of subsequences in common and the associated position on the reads with which the subsequences correspond can be used to verify overlap.

The method can include the step of using the linking information associated with the reads to confirm that the merged pairs are merged correctly. The method can include the step of using the associated linking information to an ambiguity in the merged reads. The method can include the step of identifying a repeat region and a set of unique regions. The method can include the step of linking pairs of unique regions using the linking information associated with the reads in the unique regions. The method can include the step of inserting the repeat region between each linked pair of unique regions with which the repeat region corresponds. The method can include the step of merging linked pairs of unique regions using the linking information associated with the reads in the unique regions.

In another aspect, the present invention features a method for assembly of merged reads from a genomic region. The method includes the steps of providing one or more sets of merged reads from a genomic region including a set of reads having associated linking information, using the associated linking information to identify an ambiguity in the merged reads, identifying a repeat region and a set of unique regions, and linking pairs of unique regions using the linking information associated with the reads in the unique regions.

The method can include the step of inserting the repeat region between each linked pair of unique regions with which the repeat region corresponds. The method can include the step of

merging linked pairs of unique regions using the linking information associated with the reads in the unique regions.

In yet another aspect, the present invention features an article of manufacture having computer-readable program means embodied thereon for assembly of a plurality of reads from a genomic region. The article includes computer-readable program means for providing a plurality of reads from a genomic region, computer-readable program means for indexing a plurality of read subsequences for each of the plurality of reads, each subsequence having an associated read with which it corresponds, computer-readable program means for extracting from the indexed subsequences a plurality of read pairs that have a predetermined number of subsequences in common, and computer-readable program means for merging the read pairs along a continuum.

In yet another aspect, the present invention features an article of manufacture having computer-readable program means embodied thereon for assembly of merged reads from a genomic region. The article includes computer-readable program means for providing one or more sets of merged reads from a genomic region including a set of reads having associated linking information, computer-readable program means for using the associated linking information to identify one or more ambiguities in the merged reads, computer-readable program means for identifying a repeat region and a set of unique regions, and computer-readable program means for linking pairs of unique regions using the linking information associated with the reads in the unique regions.

In short, the invention provides the art with a heretofore unappreciated method for assembling genomic sequences that allows for sequencing errors, reduces the number of read comparisons, and resolves ambiguities due to repetitive regions in the genome.

These and other objects of the present invention, along with advantages and features of the invention disclosed herein, will be made more apparent from the description, drawings and claims that follow.

### BRIEF DESCRIPTION OF THE DRAWINGS

The invention is pointed out with particularity in the appended claims. The drawings are not necessarily to scale and simplified for the sake of clarity and brevity, emphasis instead generally being placed upon illustrating the principles of the invention. The advantages of the invention can be better understood by reference to the description taken in conjunction with the accompanying drawings, in which:

FIGS. 1A-D are conceptual diagrams illustrating an exemplary embodiment of a method of providing a plurality of reads from a genomic region in accordance with the present invention;

FIG. 2 is an illustration of a exemplary embodiment of a method of indexing a plurality of read subsequences for each of a plurality of reads, each subsequence having an associated read with which it corresponds, in accordance with the present invention;

FIG. 3 is an illustration of an exemplary embodiment of a method of extracting from indexed subsequences a plurality of reads pairs that have a predetermined number of subsequences in common, in accordance with the present invention;

FIG. 4 is a illustration of an exemplary embodiment of a method of merging read pairs along a continuum in accordance with the present invention;

FIG. 5 is a illustration of an exemplary set of merged reads having a repeat region and a set of four unique regions in accordance with the present invention;

FIG. 6 is an illustration of an exemplary embodiment of a method of using linking information to identify an ambiguity in the merged reads in accordance with the present invention;

FIG. 7 is an illustration an exemplary embodiment of a method of identifying a repeat region and a set of unique regions, in accordance with the present invention;

FIG. 8 is an illustration of an exemplary embodiment of a method of linking pairs of unique regions using the linking information associated with the reads in the unique regions, and inserting the repeat region between each linked pair of unique regions with which the repeat region corresponds, in accordance with the present invention; and

FIG. 9 is an illustration of an exemplary method of merging linked pairs of unique regions using the linking information associated with the reads in the unique regions in accordance with the present invention.

### DETAILED DESCRIPTION

In its broadest aspects, the present invention is directed to the reconstruction or assembly of an unknown source sequence of a set of nucleotides or bases {A,C,G,T} from a genomic region, given a plurality of random sequences or “reads” from the sequence. Reads typically are about 500 nucleotides long, but can be in the range from about 200 to about 1000 nucleotides long. The methods of the present invention contemplate the indexing of read subsequences for each read. Read pairs are then extracted from the index that have a number of subsequences in common. These read pairs are then merged along a continuum. This method allows for or tolerates sequencing errors because subsequences of each read are compared, as opposed to the entire read sequence. This method obviates the need to compare every read to every other read, reducing an N² number of calculations to a linear number as the number of reads increases. If the DNA is several billion nucleotides long, transformation of a polynomial N² problem to a linear problem using the methods of the present invention represents a significant improvement in efficiency and speed.

The methods of the present invention also contemplate the assembly of read pairs obtained from both ends of DNA segments. Each read in the pair has associated with it information including the approximate distance between the reads and the relative orientation of the reads. This information can be used to identify repetitive regions in the DNA and resolve ambiguities in the merged reads.

One aspect of the present invention is a method for assembly of a plurality of reads from a genomic region. The method generally includes the steps of: providing a plurality of reads from a genomic region; indexing a plurality of read subsequences for each of the plurality of reads, each subsequence having an associated read with which it corresponds; extracting from the indexed subsequences a plurality of read pairs that have a predetermined number of subsequences in common; and merging the read pairs along a continuum.

The genomic region can be from any source of DNA including human DNA. The genomic region can be the entire genome or a portion of the genome. Generally, the greater the depth of read overlap, the greater the confidence in the assembly. If the genomic region is length L, preferably enough DNA copies are provided so that the sum of the lengths of the reads is between about 2 L and 20 L. More preferably, enough DNA copies are provided so that the sum of the lengths of the reads is about 10 L. The plurality of reads from a genomic region can be provided by known methods, e.g., by shotgun sequencing using known methods.

An embodiment of this method includes the step of providing a plurality of reads generated from sequencing both ends of a plurality of DNA segments, each read having associated linking information. This linking information includes an associated orientation relative to a read from an opposite end of the DNA segment, and an associated distance from the read on the opposite end of the DNA segment.

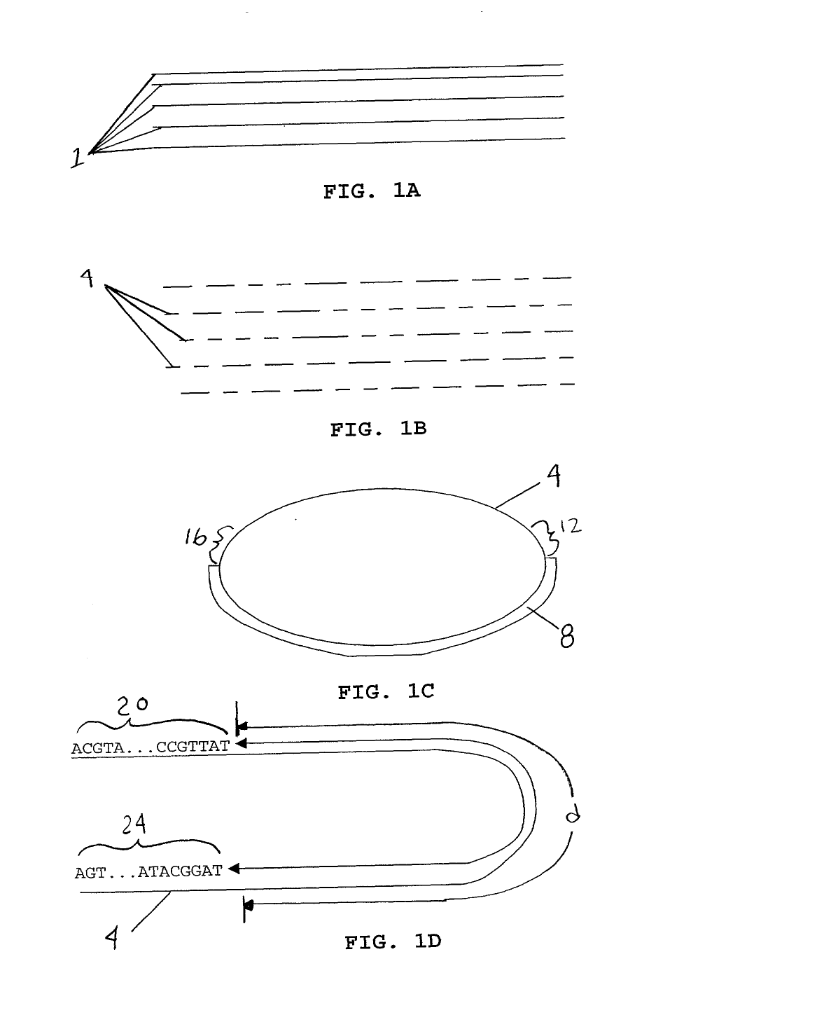

FIGS. 1A-D are conceptual diagrams illustrating an exemplary embodiment of a method of providing a plurality of reads from DNA in accordance with the present invention. FIG. 1A depicts 5 copies of a DNA sequence 1. The DNA can be any DNA, e.g., human DNA, which is roughly 3 million base pairs long. The DNA is broken up into random segments 4 as shown in FIG. 1B using methods known in the art. The segments 4 then are inserted into appropriate vectors, e.g., plasmids or cosmids, 8 using known methods as shown in FIG. 1C. Then, referring to FIG. 1D, using known methods, e.g., gel electrophoresis, typically a sequence of approximately 500 nucleotides is read from each segment end 12, 16. Thus, for each segment 4, a pair of reads 20, 24, is obtained with a known orientation relative to each other and approximate distance d from each other. That is, it is known that: read 20 has the sequence ACGTA . . . CCGTTAT; the “T” end of the read 20 is oriented toward read 24; the read 24 has the sequence AGT . . . ATACGGAT; the “T” end of read 24 is oriented towards read 20; and the approximate distance, d, between read 20 and 24 because we know the length of segment 4 inserted into vector 8. The reads are sequenced from the ends of segment 4, one from the forward strand of DNA and one from the cDNA strand.

The segments can be of varying length. For example, the segments can all be relatively short, e.g., 2,000-3,000 nucleotides long, or relatively long, e.g., about 150,000 nucleotides long. Alternatively, the segments can include groups of varying segment lengths, e.g., in an embodiment of the present invention, approximately one-tenth of the segments used to generate the reads are about 40,000 nucleotides long and approximately nine-tenths of the segments are about 4,000 nucleotides long.

The method preferably includes the step of providing a plurality of reads that are reverse complements of the plurality of reads provided by sequencing both ends of a plurality of DNA segments. These reverse complement reads can be provided by reversing the nucleotide sequence order and substituting each base with its Watson-Crick complement: A [symbol] T and C [symbol] G. Each of these reverse complement reads preferably are associated with the linking information discussed above including the orientation of the read relative to the read on the other end of the segment, and the approximate distance from the read to the read on the other end of the segment.

Providing the reverse complement reads is preferred because the relative direction of each read, or pair of reads obtained from reading off both ends of a DNA segment, is not known relative to the other reads. Without these reverse complement reads, only about half of the read overlaps would be detected when merging the read subsequences. For example, consider a read that includes the subsequence CCGAATGA. Reads including the sequence CCGAATGA can readily be detected as possibly overlapping. However, reads including the reverse complement sequence TCATTCGG would not be detected. The plurality of reads provided can also include reads without any associated link information and/or reads taken from known portions of the genomic region.

The method includes the step of indexing a plurality of read subsequences for each of the plurality of reads, each subsequence in the index is associated with its corresponding read. Each subsequence in the index also can have a “forward” or “reverse” direction associated with it.

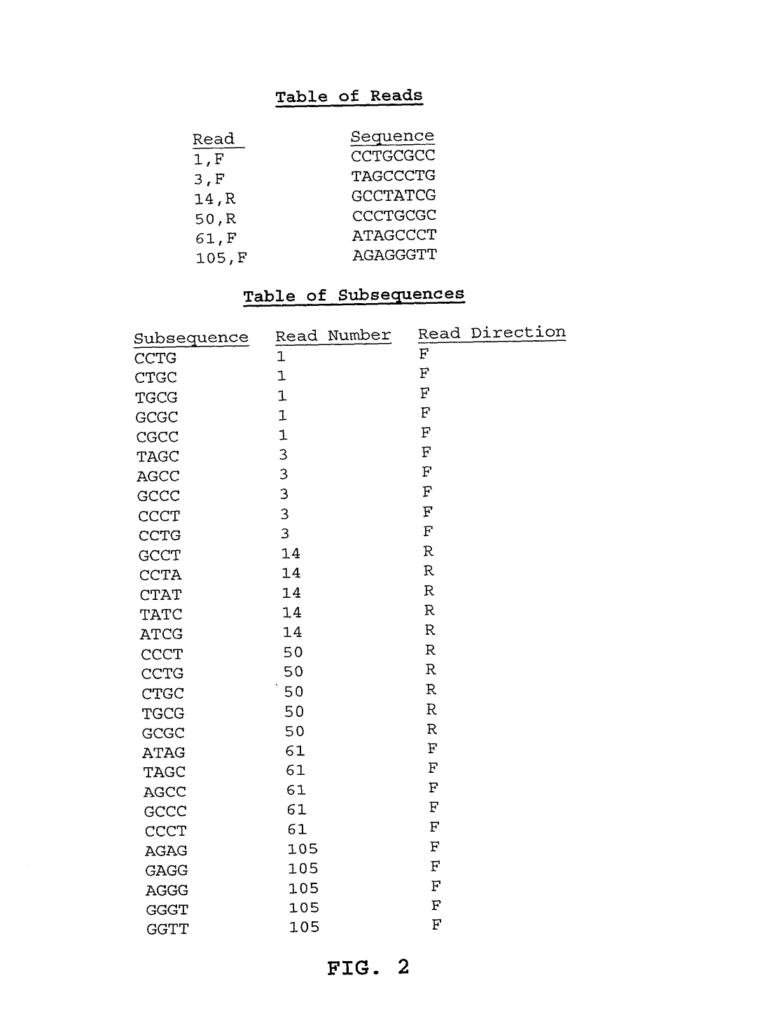

FIG. 2 is an illustration of an exemplary method of indexing read subsequences in accordance with the present invention. FIG. 2 depicts a Table of Reads and a Table of Subsequences. The Table of Reads includes each read sequence and a read number assigned each read for identification purposes. For the purposes of this illustration, only 6 reads are shown and the reads are only 8 nucleotides long, however, in practice typically there are many more reads, each about 500 nucleotides long. This table also includes an indication of whether each sequence is from the forward or reverse complement read. From the Table of Reads, an index of subsequences is created, as illustrated in the Table of Subsequences. The Table of Subsequences includes every subsequence of each read.

Each subsequence is associated with a read number and a read direction corresponding to whether the subsequence corresponds to a read provided from reads generated from sequencing both ends of a DNA segment (F), or a reverse complement of these reads (R). For example, read number 1 has the sequence CCTGCGCC. It has 5 subsequences that are 4 bases long. Its 4-mers are: CCTG, CTGC, TGCG, GCGC and CGCC. These subsequences are depicted as the first 4 entries in the Table of Subsequences associated with its read number and read direction. The reverse complement of read 1 is GGCGCAGG. It's 4-mers are GGCG, GCGC, CGCA, GCAG and CAGG. These subsequences are not depicted in FIG. 2 for the sake of brevity, but would also be included in the index in the practice of this embodiment.

For the purposes of illustration, the subsequences in FIG. 2 are 4 nucleotides long. In practice, the subsequences can be of any predetermined length (k-mers) or of random lengths. If a predetermined length is used, preferably its between about 12 and about 32 nucleotides long, more preferably between about 20 and about 27 nucleotides long, and most preferably about 24 nucleotides long. These lengths allow or tolerate for sequencing errors that occur in about 2% of the nucleotides. For example, consider a first read of 500 nucleotides that has errors at nucleotide numbers 2, 50, 99, 157, 206, 240, 359, 361, 399 and 411, and an overlapping read of 520 nucleotides with errors at nucleotides corresponding to the first read's nucleotide numbers 8, 15, 120, 165, 199, 280, 310, 330, 450 and 458. There are several regions where 24-mers can be error-free and thus overlap between 24-mers readily can be detected, e.g., between reads 16-49, 51-98, 119-156 and 166-198.

The Table of Subsequences depicted in FIG. 2 can include additional information. For example, the Table of Subsequences can include information about the position of the subsequence along the read. As discussed below, this information can be useful when performing alignments on read pairs so that overlap can be verified.

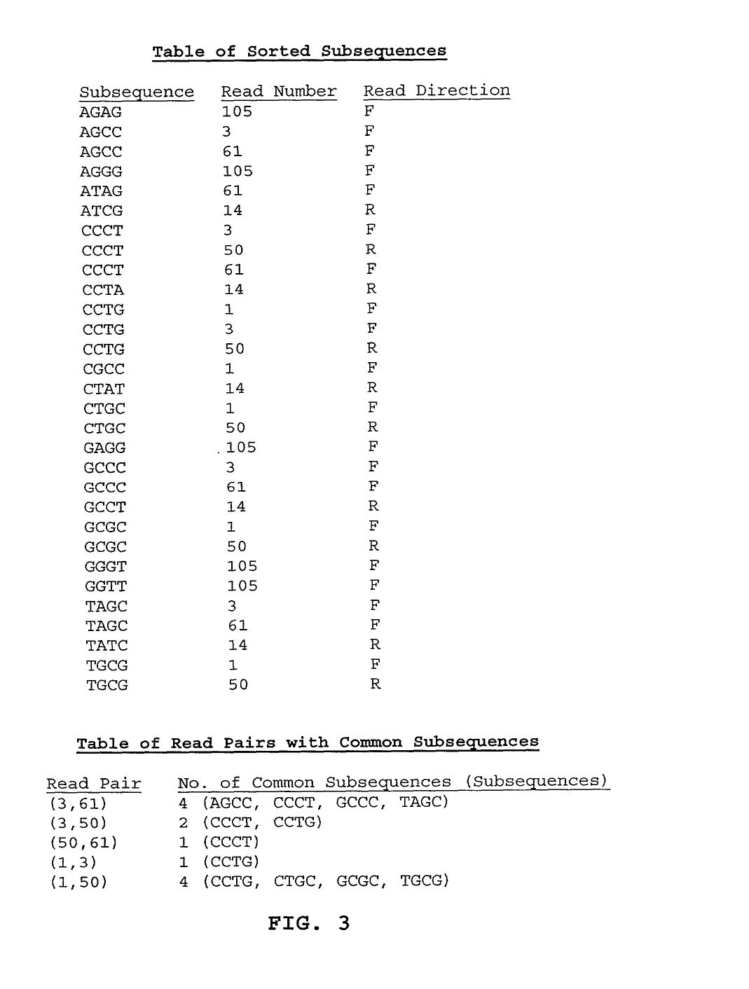

The indexed subsequences can be sorted as shown in FIG. 3. The sort can be by nucleotide. The sort can be used to create an index where identical subsequences are adjacent to one another in the index so that read pairs having subsequences in common readily can be identified. For example, FIG. 3 shows us that subsequence AGCC is common to reads 3 and 61, and subsequence CCCT is to reads 3, 50 and 61.

The method can further include the step of discarding read subsequences having more than a cutoff number of occurrences, from the indexed subsequences. This step can be used, e.g., to remove from the index subsequences that are repeated so many times that it is not efficient to include them for the purposes of detecting read overlaps. For example, in the human genome, the nucleotide sequence for the amino acid Alu is repeated as many as a million times throughout the genome, and so it is not efficient to consider the nucleotide codign for Alu subsequences when attempting to detect read overlaps. The cutoff number can be determined by the initial redundancy of sequencing that was used. For instance, if the total length of the reads is 10 L, where L is the length of the genome in nucleotides, the initial redundancy of sequencing is 10, and therefore an average region of the genome is expected to be represented 10 times by reads. Therefore, a subsequence that occurs considerably more than 10 times is likely to be repetitive. A subsequence that occurs 100 times is likely to be so repetitive that it is not efficient to include it for the purposes of detecting overlaps, and such subsequences can be discarded. The best cutoff number is the largest cutoff number that allows for an acceptably low number of pairwise comparisons.

A Table of Sorted Sequences, such as that depicted in FIG. 3, can also include a “Remove Flag” column (not shown) that identifies subsequences that occur more than a cutoff number of times. This step can be used to remove highly repetitive subsequences from consideration to increase the efficiency of the merging step, since these subsequences likely will falsely indicate overlap between the reads in which they appear.

The method further includes the step of extracting from the indexed subsequences a plurality of read pairs that have a predetermined number of subsequences in common. The common subsequence or subsequences indicate that the read pair has at least some region or regions of overlap. This method reduces the number of read comparisons that have to be performed to merge the pairs from the number of reads squared (N²) to the number of pairs that have one or more common subsequence.

The predetermined number of common subsequences can be 1 or higher. Preferably, the predetermined number is 1. However, if a collection of reads having a large percentage of errors were to be assembled, the subsequence length can be small and the predetermined number greater than 1 so that overlaps could be detected despite the errors. Generally, the higher the predetermined number, the greater the chance that a region of overlap can be missed, and the smaller the number of extracted read pairs.

FIG. 3 is an illustration of an exemplary method of extracting read pairs having common subsequences by building a Table of Read Pairs with Common Subsequences from a sorted Table of Sorted Subsequences in accordance with the present invention. The Table of Sorted Subsequences is a sorted index of the Table of Subsequences depicted in FIG. 2. The Table of Read Pairs with Common Subsequences is generated from the Table of Sorted Sequences by extracting a list of read pairs having at least 1 subsequence in common. Each read pair is associated with the number of common subsequences indicated in parenthesis.

FIG. 3 illustrates that this method of indexing the subsequences and extracting the read pairs having common subsequences significantly reduces the number of read comparisons for the merge from the number of reads squared (N²), to the number of read pairs that have one or more common subsequences. For example, using the method of the present invention, read 1 will be compared with reads 3 and 50, but not with 61 or 14, whereas with an N² comparison method, read 1 would be compared with every other read, including 14 or 61. Similarly, because read 105 has no subsequences in common with reads 1, 3, 14, 50 and 61, these comparisons are not made. This method can include sorting the table of subsequences by nucleotide.

The method further includes the step of merging the read pairs along a continuum. The pairs extracted from the index are compared; if they overlap, they are aligned and merged along a continuum. This step can include the step of performing alignments on the extracted read pairs to confirm that the reads overlap. Methods of performing alignments are known.

FIG. 4 is an illustration of an exemplary method of merging read pairs along a continuum. This merge can be performed by choosing one read pair, e.g., read pair (3,61) from FIG. 3. A direction is arbitrarily chosen for the first alignment, in this case, it is decided to represent the reads from left to right. Pair (3,61) is aligned along a continuum running from left to right. Next, a read pair can be chosen that includes one of the reads in the pair already aligned. Pair (3,50) can be chosen, e.g., and read 50 aligned with read 3 in FIG. 4. The merge can be built pair by pair as shown in FIG. 4. It should be noted that read 14, shown in FIG. 4, would not be aligned from the data shown in FIG. 3 because it does not share a common subsequence with the other reads shown. However, as the reads are merged with data not shown in FIG. 4, other pairs can be aligned until a read is added that has a subsequence in common with read 14, and read 14 would be merged. From the merged reads, the resolved sequence ATAGCCCTGCGCCTATCG, indicated below the continuum line in FIG. 4, can be obtained.

Alignments optionally can use the associated position of the subsequences on the reads to confirm overlap. For example, consider the two sequences: GATCCCATGCGCA and ATAGCCCTATGAT. These sequences share common subsequences GAT and CCC. We know from the associated position information that CCC begins at base 4 for the former and base 5 for the latter, and the GAT subsequence begins at base 1 for the former and base 11 for the latter. This position information indicates that there is no overlap between these two sequences since the position of the common subsequences does not allow for alignment. Consider now the first sequence above and the sequence CCCATGCGCATAT. We know that the common subsequence CCC begins at base 4 for the former and base 1 for the latter, and the common subsequence CCC begins at base 9 for the former and base 6 for the latter. This position information indicates that there is overlap between these two sequences. Comparing the rest of the intervening subsequences confirms the overlapping region CCCATGCGCA.

The method can further include the step of using the linking information associated with the reads to confirm that the merged pairs are merged correctly. The linking information can include the relative orientation of the reads and the approximate distances between the reads. This information can be used to confirm the merged reads, by checking for some or all of the reads, whether they have been merged such that the relative orientation of the reads and the distance between the reads are consistent with the linking information.

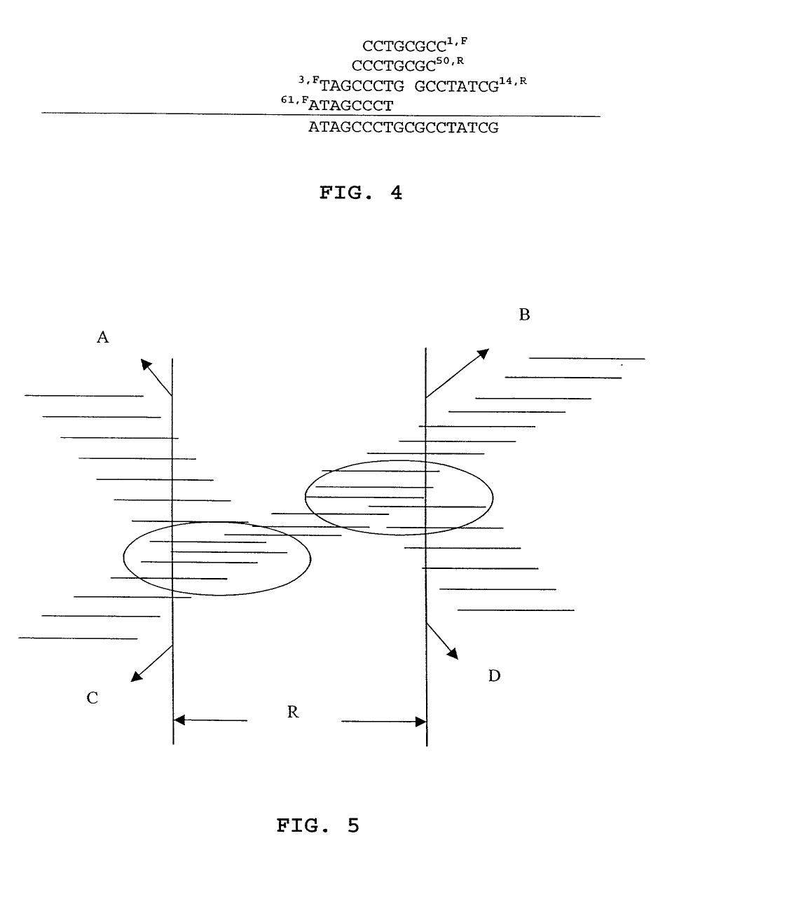

The merge can contain ambiguities as encircled in FIG. 5, where it appears that there is a divergence in the sequence. These ambiguities are due to repeat regions in the DNA, and are discussed below.

The merge can also contain discontinuities (not shown). That is, there can be gaps in the merge where regions of overlap were not identified and thus the merge can yield two or more merged regions of pairs. From the merged pairs alone, the relative orientation of the merged regions along the continuum is unknown. However, as discussed below, the relative orientation of these regions can be determined using linking information.

As noted above, FIG. 5 depicts a read merge that contains encircled ambiguities where the sequence appears to diverge. FIG. 5 is a illustration of an exemplary set of merged reads, represented by overlapping lines, having a repeat region R and a set of four unique regions A, B, C, and D. This merge is ambiguous because it is not known how the regions should are linked because of the presence of repeat region R. That is, it is not known whether regions A, C, B, D should be combined such that regions A-R-B and C-R-D are linked in the genome, or A-R-D and regions C-R-B are linked in the genome. FIG. 5 depicts a merge having 4 unique regions A, B, C, D for the sake of illustration, however, in practice merges can have a large number of unique regions when repetitive region R is repeated a large number of times in the genome. How these regions are linked can be difficult, if not impossible, to determine with read subsequences alone.

Another aspect of the present invention is a method for assembly of merged reads from a genomic region. This method addresses the difficulty of ordering ambiguous merges. The method generally includes the following steps: providing one or more sets of merged reads from a genomic region, the merged reads including a plurality of reads generated from sequencing both ends of a plurality of DNA segments, each read having associated linking information including an associated orientation relative to a read from an opposite end of the DNA segment, and an associated distance from the read on the opposite end of the DNA segment; identifying one or more ambiguities in the merged reads where the merged reads diverge; using the associated linking information to identify a repeat region and a plurality of unique regions; and linking pairs of unique regions using the linking information associated with the reads in the unique regions.

The one or more sets of merged reads provided can include merges provided using the methods of the present invention as described above. Additionally or alternatively, the set of merges can include merges built using other known methods such as those created by performing N² alignments. At least some of the merged reads include a plurality of reads generated from sequencing both ends of a DNA segment as described above. These reads each have associated linking information including an associated orientation relative to a read from an opposite end of the DNA segment, and an associated distance from the read on the opposite end of the DNA segment. Optionally, the merged reads can include reads that are not generated from sequencing both ends of a DNA segments. Optionally, the merged reads can include sequences obtained using other sequencing techniques known in the art, e.g., nucleotide tagging and sequencing, provided that linking information in known for at least some of the “reads” embedded in the sequence.

The method includes the step of using the associated linking information to identify one or more ambiguities in the merged reads. An ambiguity is detected when overlapping reads have read pairs that are contained in two distinct merged regions which, according to the linking information, should also overlap, but do not.

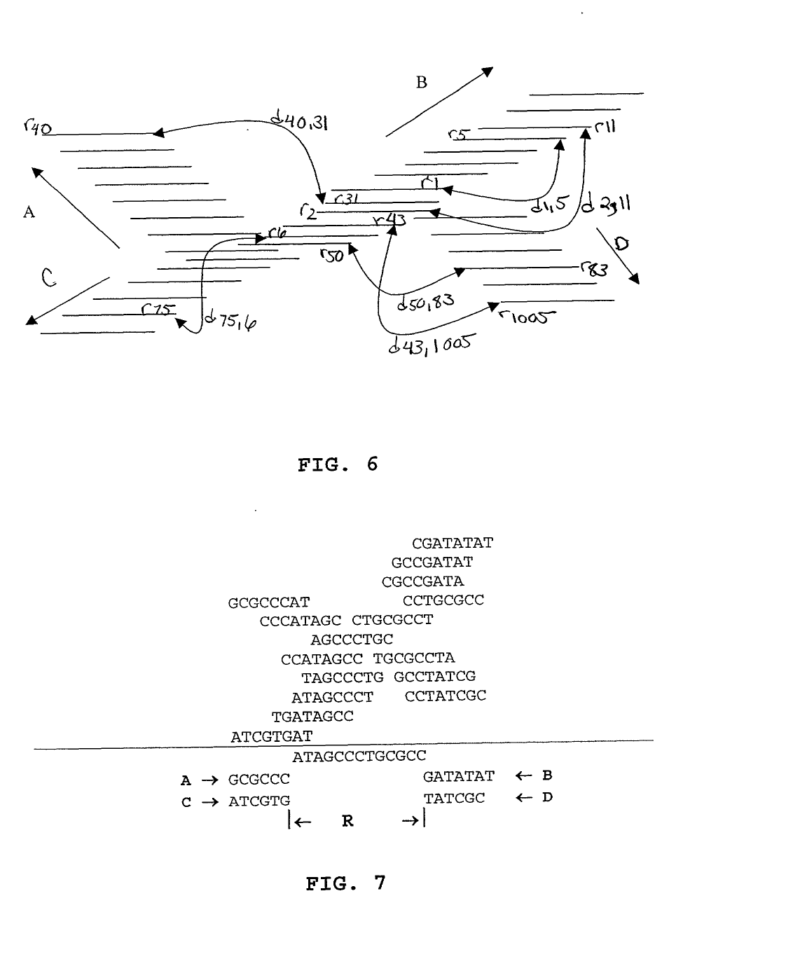

FIG. 6 is an illustration of an exemplary method of using the associated linking information to identify one or more ambiguities in the merged reads, in accordance with the present invention. FIG. 6 depicts an exemplary set of merged reads r₁, r₂, r₃l, r₄₃, r₅₀ and r₆. The ambiguity can be detected by choosing two reads in the same set of merged reads, e.g., reads r₁ and r₅₀. The reads in FIG. 6 are indicated as rₙ, where n is the read number. In this example, the reads were generated from sequencing both ends of both strands of a DNA segment and so approximate distance d_{1,5} between r₁ and r₅ and distance d_{50,83} between r₅₀ and r₈₃, and relative orientation of the reads, as indicated by the arrow heads are known. Reads r₅ and r₈₃ are in unique merged regions B and D. This information tells us that B and D should overlap, however, a comparison of the sequences of B and D show that there is no overlap. This indicates that there is an ambiguity in the reads. A similar analysis of linking information between, e.g., r₄₀ and r_{31,} and r₇₅ and r_{6,} tells us that A and C should overlap, however a comparison of these sequences show that there is no overlap, indicating that there is an ambiguity in the reads.

The method further comprises the step of identifying a repeat region and a set of unique regions. Once the ambiguity is identified, a review of the sequences of the merged reads about the ambiguous regions yields the identity of the repeat and unique regions. Generally, each “arm” or branch about the ambiguous regions is a unique region, and the region between the ambiguous regions is the repeat region.

FIG. 7 is an illustration of an exemplary method of identifying a repeat region R and a set of unique regions A, B, C, D, in accordance with the present invention. By distilling the sequences of the merged reads, as shown in FIG. 7, the portion of the merged reads that is not branched can be identified as repeat region R, and the arms or branches are unique regions A, B, C, D. Only two unique regions are shown on each side of repeat region R for the sake of illustration. However, in practice a repeat region can be flanked by more unique regions depending on the number of times the repeat region appears in the genome.

The correct assembly of the regions is not known from the information depicted in FIG. 7. That is, it is not known if regions A and B flank one copy of repeat region R and regions C and D the other, or whether unique regions A and D flank one copy of repetitive region R and C and B the other.

The method further comprises the step of linking pairs of unique regions using the linking information associated with the reads in the unique regions. Using linking information between reads in the unique regions, the correct assembly of the unique regions can be determined. After the unique regions are linked, if the repeat region was removed from between the unique regions, the method can comprise the step of inserting the repeat region between each linked pair of unique regions with which the repeat region corresponds.

FIG. 8 is an illustration of an exemplary method of linking pairs of unique regions using the linking information associated with the reads in the unique regions, and inserting the repeat region between each linked pair of unique regions with which the repeat region corresponds, in accordance with the present invention. The correct assembly of the unique regions can determined by searching or otherwise identifying reads in the unique regions with linking information to reads also in the linking regions. For example, FIG. 8 depicts a link between reads 111 and 62 (r₁₁₁, r₆₂), with a known orientation relative to each other and a known distance between reads, d_{111,62}. It also shows reads 320 and 305 (r₃₂₀, r₃₀₅), with a known orientation relative to each other and a known distance between the reads d_{320,305}. From this linking information, it can be determined that regions A and D flank one copy of repeat region R, and regions B and C flank a second copy of repeat region R. Once the linked pairs are identified, the method can optionally include inserting the repeat region between the linked pairs it corresponds to as shown in FIG. 8. What is not known from the information depicted in FIG. 8 is how the linked pairs of unique regions are oriented relative to each other and at what distance.

The method of the present invention can include the step of merging linked pairs of unique regions using the linking information associated with the reads in the unique regions. The linked pairs of unique regions to be merged can be from several sets of merged reads having ambiguities.

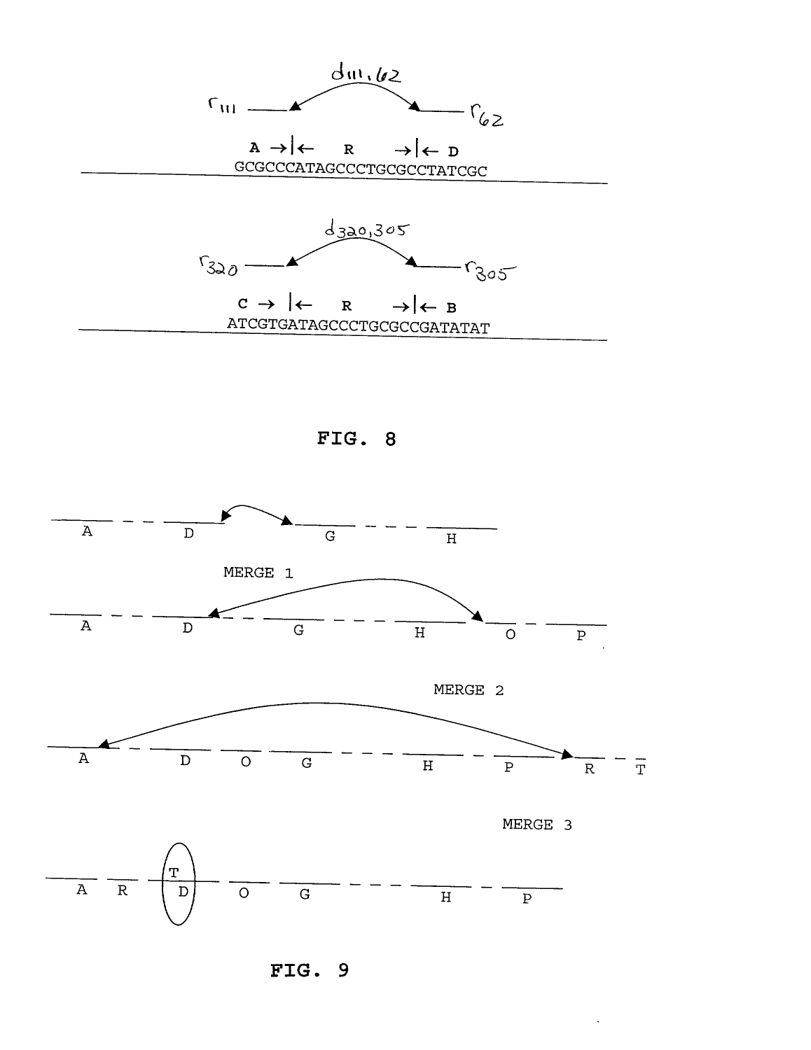

FIG. 9 is an illustration of an exemplary method of merging linked pairs of unique regions using the linking information associated with the reads in the unique regions in accordance with the present invention. In FIG. 9, unique regions D and G are linked by reads in these regions that are generated from both ends of a DNA segment having an approximate distance and known orientation relative to each other. This information indicates the relative distance and orientation of unique regions A-D and unique regions G-H. Merge 1 is possible because G-H can be placed on a continuum with A-D without causing a divergence in the sequence. The dashed lines indicate a repetitive region.

In Merge 2, unique regions D and O are linked by reads in these regions as well. This information indicates the relative distance and orientation of A-D-G-H and O-P. Merge 2 is possible because A-D-G-H can be merged without causing a divergence in the sequence.

In Merge 3, unique regions A and R are linked by reads in these regions. However, this time the distance associated with the link is not consistent with the presence of A-D-O-G-H-P, as shown by the circled region, and Merge 3 is not performed. This inconsistency can occur, e.g., if region A or R is a repetitive region, leading to inconsistent linking information. At this point the merging stops so that the ordering of non-repetitive regions is not compromised.

Practice of the invention will be still more fully understood from the following example, which are presented herein for illustration only and should not be construed as limiting the invention in any way.

### Example

Simulated Assembly of Chromosome 22 of the Human Genome

The method was used to assemble shotgun reads from the chromosome 22 of the human genome. Simulated reads were created from the real sequence of chromosome 22. All of the reads came from earmuff links. Approximately 350,000 random segments were taken from approximately 10 copies of chromosome 22. Approximately one-third of these segments were about 10,000 bases long and about two-thirds of the segments were about 3,000 bases long. The former were simulating the insertion into long plasmid vectors and the latter into short plasmid vectors, and the approximately the first and last 500 bases from each end of the segments were sequenced. Sequencing errors were distributed uniformly at random and were present in an average error rate of 0.5% for mutations, 0.05% or insertions and 0.05% for deletions. The distance between the reads on the segments and the relative orientation of the reads were recorded. The earmuff link distances had an average error of 5%. Reverse complement reads were provided that were reverse complements of the reads provided by sequencing both ends of the DNA segments.

An index of 700,000,000 subsequences 24 bases long was generated for each of the reads, each having an associated read number. The index was sorted according by subsequence, and subsequences that had more than 100 occurrences were discarded. From this index, approximately 28,000,000 pairs (approximately 40 times the number of reads) were extracted that had at least 1 subsequence in common.

These read pairs were merged along a continuum to provide 4,200 sets of merged reads. Ambiguities were identified in 1,300 sets of merged reads using linking information. The repeat regions and unique regions were identified. The unique regions were linked using linking information associated with reads in the unique regions. The linked pairs were merged using linking information associated with the reads in the unique regions. The repetitive regions were then inserted between each linked pair of unique regions with which the repeat corresponds. This method was processed by a single Alpha processor with 2 Gb memory and 50 Gb storage and took about 15 hours to complete.

Equivalents

The present invention can be implemented as one or more computer-readable software programs embodied on or in one or more articles of manufacture. The article of manufacture can be, for example, any one or combination of a floppy disk, a hard disk, hard-disk drive, a CD-ROM, a DVD-ROM, a flash memory card, an EEPOM, an EPROM, a PROM, a RAM, a ROM, or a magnetic tape. In general, any standard or proprietary, programming or interpretive language can be used to produce the computer-readable software programs. Examples of such languages include C, C++, Pascal, JAVA, BASIC, Visual Basic, and Visual C++. The software programs may be stored on or in one or more articles of manufacture as source code, object code, interpretive code, or executable code.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method for assembly of a plurality of reads from a genomic region, the method comprising the steps of:
providing a plurality of reads from a genomic region;
indexing a plurality of read subsequences for each of the plurality of reads, each subsequence having an associated read with which it corresponds;
extracting from the indexed subsequences a plurality of read pairs that have a predetermined number of subsequences in common; and merging the read pairs along a continuum.

2. The method of claim 1, comprising the step of providing a plurality of reads generated from sequencing both ends of a plurality of DNA segments, each read having associated linking information comprising an associated orientation relative to a read from an opposite end of the DNA segment, and an associated distance from the read on the opposite end of the DNA segment.

3. The method of claim 1, comprising the step of providing a plurality reads that are reverse complements of a plurality of reads provided by sequencing both ends of a plurality of DNA segments.

4. The method of claim 1, comprising the step of sorting the indexed read subsequences.

5. The method of claim 1, comprising the step of discarding read subsequences having more than a cutoff number of occurrences from the plurality of indexed subsequences.

6. The method of claim 1, comprising the step of indexing a plurality of read subsequences of a predetermined length for each of the plurality of reads.

7. The method of claim 6, wherein the predetermined length for each of the plurality of reads is between about 12 and about 32 bases long.

8. The method of claim 1, comprising the step of indexing a plurality of subsequences for each read, the index comprising for each subsequence an associated read and an associated position on the read with which it corresponds.

9. The method of claim 1, comprising the step of performing alignments on the plurality of read pairs having a predetermined number of subsequences in common.

10. The method of claim 8, comprising the steps of:
performing alignments on the plurality of read pairs having a predetermined number of subsequences in common; and
using the associated position on the reads with which the subsequences correspond to verify overlap.

11. The method of claim 2, comprising the step of using the linking information associated with the reads to confirm that the merged pairs are merged correctly.

12. The method of claim 2, comprising the step of using the associated linking information to an ambiguity in the merged reads.

13. The method of claim 12, comprising the step of identifying a repeat region and a set of unique regions.

14. The method of claim 13, comprising the step of linking pairs of unique regions using the linking information associated with the reads in the unique regions.

15. The method of claim 14, comprising the step of inserting the repeat region between each linked pair of unique regions with which the repeat region corresponds.

16. The method of claim 13, comprising the step of merging linked pairs of unique regions using the linking information associated with the reads in the unique regions.

17. A method for assembly of merged reads from a genomic region, the method comprising the steps of:
providing one or more sets of merged reads from a genomic region comprising a set of reads having associated linking information;
using the associated linking information to identify an ambiguity in the merged reads;
identifying a repeat region and a set of unique regions; and
linking pairs of unique regions using the linking information associated with the reads in the unique regions.

18. The method of claim 17, comprising the step of inserting the repeat region between each linked pair of unique regions with which the repeat region corresponds.

19. The method of claim 17, comprising the step of merging linked pairs of unique regions using the linking information associated with the reads in the unique regions.

20. An article of manufacture having computer-readable program means embodied thereon for assembly of a plurality of reads from a genomic region, the article comprising:
computer-readable program means for providing a plurality of reads from a genomic region;
computer-readable program means for indexing a plurality of read subsequences for each of the plurality of reads, each subsequence having an associated read with which it corresponds;
computer-readable program means for extracting from the indexed subsequences a plurality of read pairs that have a predetermined number of subsequences in common; and
computer-readable program means for merging the read pairs along a continuum.

21. An article of manufacture having computer-readable program means embodied thereon for assembly of merged reads from a genomic region, the article comprising:
computer-readable program means for providing one or more sets of merged reads from a genomic region comprising a set of reads having associated linking information;
computer-readable program means for using the associated linking information to identify one or more ambiguities in the merged reads;
computer-readable program means for identifying a repeat region and a set of unique regions; and
computer-readable program means for linking pairs of unique regions using the linking information associated with the reads in the unique regions.
